(19) United States
(12) Patent Application Publication
(10) Pub. No.: US 2002/0058114 A1
(43) Pub. Date: May 16, 2002

(54) Colored bottle blank and forming mold set with manufacturing process thereof

(76) Inventor: Chien Min Sung, Pingtung Hsien (TW)

Correspondence Address: Dougherty & Troxell, ONE SKYLINE PLACE, SUITE 1404, 5205 LEESBURG PIKE, FALLS CHURCH, VA, 22401, US

(21) Appl. No.: 09/725,188

(22) Filed: Nov. 29, 2000

(30) Foreign Application Priority Data
Nov. 10, 2000 (TW) 89123786

(51) Int. Cl. B32B 1/08; B29D 22/00; B29C 45/00; B29C 49/00

(52) U.S. Cl. 428/35.7; 264/328.1; 425/525

(57) ABSTRACT

A colored bottle blank comprises a base blank and an outer blank. The base blank has an injected thickness from the upper part thereof extending to the bottle mouth greater than the rest part thereof. The rest part of the base blank extends outward from the inner wall thereof to constitute a recess. The outer blank is injected to form an outer wall filled with the recess. The material of the outer blank is the same material as the base blank, but the color thereof is different from that of the base blank filling with the recess. Hence, the colored blank can be formed with a homogeneous thickness.

### BACKGROUND OF THE INVENTION

1. Field of The Invention

The present invention relates to a colored bottle blank, forming mold set for making the colored bottle blank, and manufacturing process of the colored bottle blank.

2. Description of Related Art

A bottle has been used as a container since very ancient years. Nevertheless, the bottle is made differently in different eras. Due to the development of industrial technology and the progress of civilization, the material adopted for the bottle is changed from such as ceramics, metal, and glass, which are natural, to the high molecular material or so-called polyester, which is frequently used nowadays.

The high molecular container such as the high molecular bottle is malleably made by way of extending blow forming in a injection mold. The method to make the high molecular bottle is used to call blowing bottle technique. The material such as Polyester utilized to make the bottle is injected by way of injection molding to form a hollow bottle blank with a bottle mouth first. Then, the blank is placed in a extending and blowing mold to be extended and blown so as to constitute a bottle body with empty interior. The extending and blowing process can be completed either in one step or two steps, and basically, the bottle mouth with a part for engaging a bottle cap has to be integrated with the hollow body after the manufacturing process is complete.

Furthermore, while the bottle body is used for containing fluid merchandise especially those popularly sold in the consumer market such as juice, and beverage, it is necessary to add a sticker or print a mark on the bottle body in order to emphasize the feature of the merchandise. In other words, for bottles formed by way of various are provided with a single color only such that there is no any other visional enhancement for the bottle except the configuration of the bottle body.

### SUMMARY OF THE INVENTION

An object of the present invention is to provide a colored bottle blank, forming molds for the colored blank, and manufacturing process of the colored bottle blank such that a bottle blank with at least two colors can be made effectively.

### BRIEF DESCRIPTION OF THE DRAWINGS

The present invention can be more fully understood by referring to the following description and accompanying drawings, in which:

FIG. 1 is a sectional view of a base mold according to the present invention with a base blank therein;

FIG. 2 is a sectional view of a second mold according to the present invention with a second blank therein;

FIG. 3 is a sectional view of a third mold according to the present invention with a third blank therein;

FIG. 4 is a sectional view of the finished mold according to the present invention with a finished bottle blank therein; and

FIG. 5 is a block diagram illustrating steps to form the colored bottle blank.

### DETAILED DESCRIPTION OF THE PREFERRED EMBODIMENTS

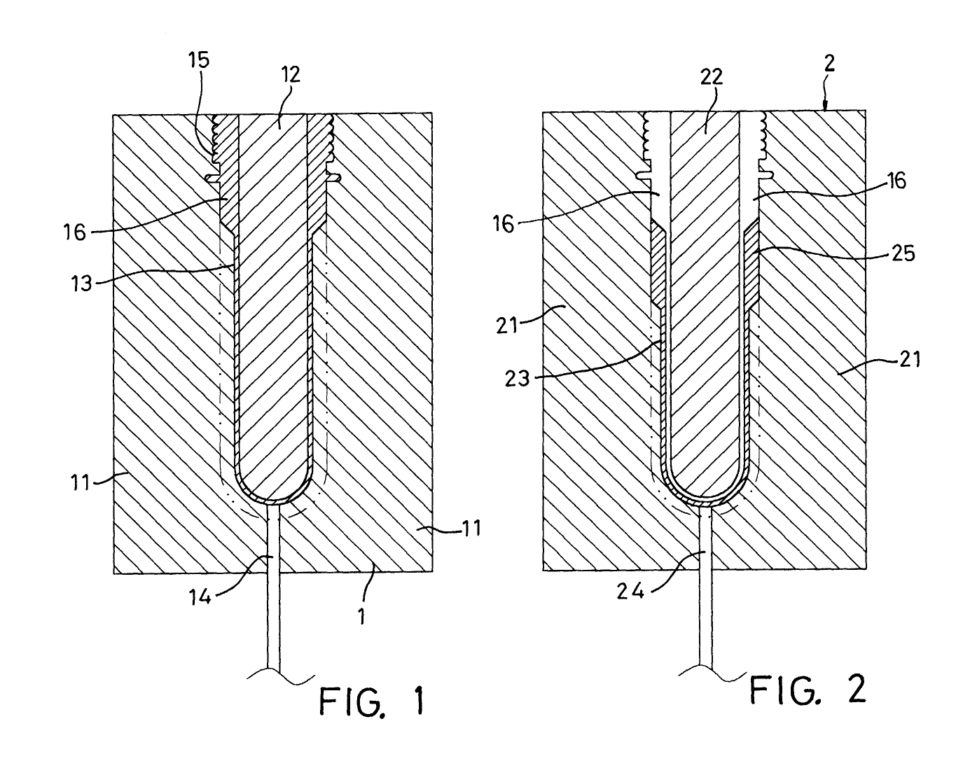

Basically, the preferred embodiment illustrated in FIGS. 1 to 5 is for a bottle blank with four colors, but it may be applied for a bottle blank with either two colors or more than two colors as desired.

Referring to FIG. 1, the base mold 1 is composed of two separable mold halves 11 and a mold core 12 is located at the center of the base mold 1. An annular receiving groove 13 is formed between the mold core 12 and said two mold halves 11 and a passage 14 communicates with the receiving groove 13 for injected material being able to enter the receiving groove 13 through the passage 14 and form a bottle blank therein. As shown in FIG. 1, the receiving groove 13 in the base mold 1 is provided with a bottle mouth 15 and an inner wall of the bottle blank. The dash line in FIG. 1 indicates the outer contour line of a finished bottle blank such that the lower part of the base mold 1 is arranged to have a thicker wall. A first colored blank 16 with a thick upper portion and a thin lower portion is formed in the receiving groove 13 and includes the bottle mouth 15.

Referring to FIG. 2, a second mold 2 is similar to the base mold 1 shown in FIG. 1 and provided with a second mold core 22. The difference of the second mold 2 from the base mold 1 is that the respective mold halve 21 of the second mold 2 has a wall thickness smaller than that of the base mold 1. In addition, a second receiving groove 23 is formed between the first color blank 16 and the inner wall of the mold to communicate with a second material passage 24. After the second receiving groove 23 having been injected with material, a second colored blank 25 may be formed to coat the lower portion of the first colored blank 16.

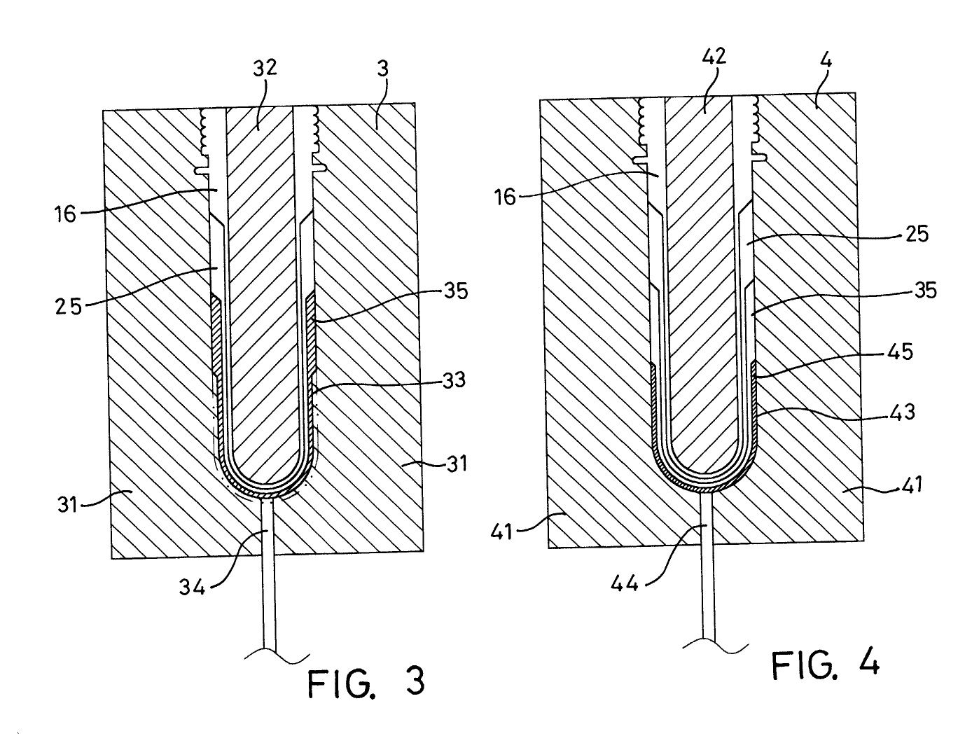

Referring to FIG. 3, a third mold 3 is similar to the base mold 1 and the second mold 2 shown in FIGS. I and 2 and provided with a mold core 32 at the center thereof too. The respective mold halves 31 of the third mold 3 has a wall thickness smaller than that of the respective mold halve 21 of the second mold 2. In the meantime, a third receiving groove 33 is formed to surround the second colored blank 25 from the upper end thereof extending downward to the lower part thereof. A third material passage 34 communicates the third receiving groove 33 such that a third colored blank 35 may be formed to coat the lower part of the second colored blank 25 after the material has been injected into the third receiving groove 34.

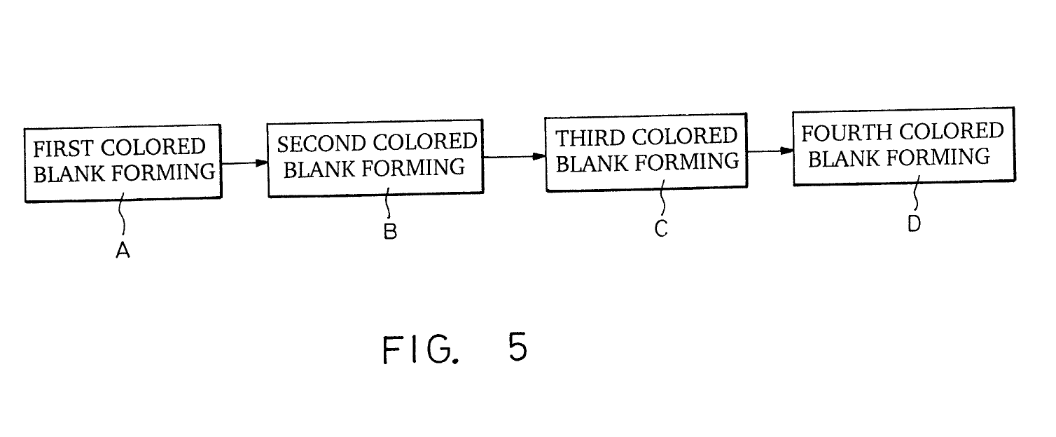

Referring to FIG. 4, the fourth mold 4 is similar to preceding molds and composed of two mold halves 41 with a center mold core 42. The respective mold half 41 has a fourth receiving groove 43 therein and the outer wall surface is corresponding to the contour on the bottle blank. A fourth material passage 44 is provided to communicate the fourth receiving groove 43. A fourth colored blank 45 is formed to cover the lower part of the preceding third colored blank 35 after the material has been injected into the fourth receiving groove 43 through the material passage 44. As shown in FIG. 4, the fourth colored blank 45, the third colored blank 35, the second colored blank 25, the first blank, and the bottle mouth 15 make the finished bottle blank provide with different colors due to different colored materials.

Based on the principle of mixing colors, a colored bottle blank with various colored blank sections can be obtained successfully. For instance, colors for colored blanks can be arranged as the following description. The first colored blank 16 is chosen colorless and transparent. The second colored blank 25 may be yellow, green, or blue, or other multiple colors. The third colored blank 35 is a color other than preceding colors, and the fourth colored blank is provided with a color different from those on preceding colored blanks. Once the colored bottle blank is complete, a colored bottle body with different colored sections and a variety of colors can be received after subsequent process of extending and blowing.

As for the non-transparent material being used, the bottle blank with different colored sections can be obtained as well. Each colored section can be contour or wavy at the margin thereof or can be formed with other preset sectional division thereof based on the design of mold. This is prior art in the field of mold designing and no detail will be described further.

Referring to FIG. 5, a manufacturing process according to the present invention is illustrated by way of block diagram. Steps of the process shown in FIG. 5 are steps for four molds operation and include a first colored blank forming A, a second colored blank forming B, a third colored blank forming C, and a fourth colored blank forming D.

The step of first colored blank forming A is that the material is injected into the preceding base mold 1 to perform a injection forming and obtain the first colored blank 16 after opening the base mold.

The step of second colored blank forming B is that the preceding first colored blank 16 is placed in the second mold 2 and the material with another color is injected into the second mold 2. Thus, a second colored blank 25 can be obtained by way of injection forming and cover the first colored blank 16 locally.

The step of third colored blank forming C is that the preceding second colored blank 25 is placed in the third mold 3 and the material with a further color is injected into the third mold 2. Thus, a third colored blank 35 can be obtained by way of injection forming and cover the second colored blank 25 locally.

The step of fourth colored blank forming D is that the preceding third colored blank 35 is placed in the fourth mold 4 and the material with a further color is injected into the fourth mold 4. Thus, a finished colored blank can be obtained by way of injection forming and cover the third colored blank 35 locally.

Each step of injection forming may be performed by way of automation such as molding tools on a swivel table being operated sequentially. In addition, it may be done by way of the method according to the present invention that colored blanks made in two neighboring steps have a respective color different from each other. That is, the first colored blank 16 is different from the second colored blank 25 only and it is not restricted all colored blanks have a respective color, which has to be different from one another.

It is preferable that the polyester is adopted as the material for the colored bottle blank. Of course, other high molecular material also can be utilized as long as it is possible to be injected, extended, blew during the manufacturing process.

It is noted that the preceding embodiment is for four colored blanks and the present invention is suitable for at least two colored blank, i.e., a base mold can form a base blank and an outer mold can form an outer blank. The bottle mouth on the base blank with part of the base blank exposes and the rest thereof is covered by the outer blank. In this way, a bottle blank has an upper section and a lower section, and the color of the upper section and that of the lower section is different from each other. Thus, the bottle blank can be formed as a bottle body of dual colors after being extended, and blew.

It is appreciated that a colored bottle blank offered by the present invention can be extended and blown to obtain a colored bottle body provided with at least two colors. Therefore, the technique disclosed in the present invention is not possible for the blowing technique of the prior art to reach effectively.

While the invention has been described with reference to the preferred embodiments thereof, it is to be understood that modifications or variations may be easily made without departing from the spirit of this invention, which is defined by the appended claims.

What is claimed is:

1. A colored bottle blank, comprising
a base blank with a bottle mouth and a bottle body, an upper part of the bottle body extending to the bottle mouth being injected a thickness greater than a rest part of the bottle body, and the rest part of the bottle body extending outward from an inner wall thereof to constitute a recess; and
an outer blank, being an outer wall injected by way of the same material as the base blank with a color different from that of the base blank filling with the recess;
whereby, the colored blank has been formed a finished bottle body with homogeneous thickness.

2. The colored bottle blank according to claim 1, wherein at least a layer of intermediate blank is between the base blank and the outer blank with a color different from the base and the outer blanks.

3. The colored bottle blank according to claim 1, wherein the material thereof is high molecular.

4. The colored bottle blank according to claim 3, wherein the high molecular material preferably is PET (polyester).

5. The colored bottle blank according to claim 2, wherein one of the base blank, the intermediate blank, and the outer blank may be transparently colorless.

6. The colored bottle blank according to claim 1, wherein the colored bottle blank becomes a bottle after being extended and blown.

7. A manufacturing process for colored bottle blank, comprising the following steps:
a step of forming a base blank, pouring a high molecular material into an injection mold to be injected and formed a base blank with an upper part thereof including a bottle mouth having a thickness greater than a lower part thereof, and the lower part having a surrounded recess; and
a step of forming an outer blank, the base blank being placed in an injection mold for making the outer blank, pouring another high molecular material with a color different from the base blank into the injection mold to be injected and formed the outer blank filling with the recess on the base blank, and a finished bottle blank being obtained with a homogeneous wall thickness and different colors thereon.

8. The manufacturing process for colored bottle blank according to claim 7, wherein a step of forming at least an intermediate blank, which is added between the step of forming the base blank and the outer blank, is that the base blank is placed in an intermediate blank forming mold to be poured a further high molecular material and injected to form the intermediate blank, and a part of the recess is filled by the intermediate blank and the rest of the recess is for being filled by the outer blank made from the step of forming the outer blank.

9. The manufacturing process for colored bottle blank according to claim 7, wherein the high molecular material is PET.

10. The manufacturing process for colored bottle blank according to claim 7, the high molecular material may be transparent.

11. A forming mold set for colored bottle blank being a high molecular injection mold, comprising
a base mold, being composed of two mold halves, having a receiving groove part for forming a bottle mouth and an upper part of the bottle blank and a thinner receiving groove part under the receiving groove part to communicate a material passage for admitting a liquid material;
an outer mold, being composed of two outer mold halves, having a further receiving groove for making up the thinner receiving groove in the base mold, and the further receiving groove connecting with the material passage;
whereby, while the liquid material is poured into the base mold, a base blank may be formed; and when the base blank is placed in the outer mold and another liquid material having a color different from the base blank is poured into the outer mold, then a bottle blank with a homogeneous wall thickness is formed.

12. The forming mold set for colored bottle blank according to claim 11, wherein at least an intermediate mold may be added to make up a part of said thinner receiving groove and connect with said material passage, the rest part of said thinner receiving groove is made up by the outer blank so as to constitute the bottle blank with a homogeneous thickness after the intermediate blank and the outer blank are formed.
